(19) United States
(12) Patent Application Publication
(10) Pub. No.: US 2002/0051197 A1
(43) Pub. Date: May 2, 2002

(54) Public line connection device for printer and print system

(75) Inventor: Yuji Minegishi, Kanagawa (JP)

Correspondence Address: ARMSTRONG,WESTERMAN & HATTORI, LLP, 1725 K STREET, NW., SUITE 1000, WASHINGTON, DC, 20006, US

(73) Assignee: KOMATSU LTD., Tokyo (JP)

(21) Appl. No.: 09/983,341

(22) Filed: Oct. 24, 2001

(30) Foreign Application Priority Data
Oct. 26, 2000 (JP) 2000-326966

(51) Int. Cl. G06F 15/00

(52) U.S. Cl. 358/1.15

(57) ABSTRACT

The present invention permits dial-up printing to be realized, which serves for the straightforward use of a company internal printer from outside of the company LAN, whilst preventing unauthorized access to the company LAN.

A terminal device 100 and mobile terminal device 101 are connected to a public line PSTN. A printer P is connected to the public line PSTN via a public line connection device 200. The public line connection device 200 realizes a dial-up connection server function that serves to provide a PPP connection between the terminal device 100, or similar, and the printer P. A user is thus able to dial up the printer P from outside the company LAN and thus cause printed matter to be outputted by the printer P by sending print data thereto.

### BACKGROUND OF THE INVENTION

1. Field of the Invention

The present invention relates to a public line connection device, for a printer, and to a print system, which enable print data to be sent directly to a printer via a public line from a terminal device such as a personal computer or a mobile information terminal, for example.

2. Description of the Related Art

Advances in network technology and computer technology have been accompanied by the widespread usage of company internal networks in which a variety of network-compatible devices including, for example, personal computers, printers, facsimile machines, and copy machines, are connected to a company LAN(Local Area Network). Meanwhile, advances in mobile computing have also increased the demand to connect to a company LAN at any time and in any location in order to make use of company internal resources on the company LAN.

For example, there are cases in which users may wish to print out documents that have been created outside the company, on a company internal printers on the company LAN, or make printouts using private printers owned by clients who are expected to visit. In such cases, the methods below may be considered, for example. One method is to send print images by facsimile to a facsimile machines or a printer that has a facsimile function. Another method is to provide a remote access server equipped with a dial-up router in the company LAN to which the internal printer is connected, and, by means of remote access to a print server via this remote access server, to allow the internal printer which is controlled by the print server, from outside the company LAN. A further method is to make remote access to a print server by connecting to the company LAN over the Internet using VPN (Virtual Private Network) technology.

Sending documents by facsimile is simple but a drop in print quality typically has an adverse effect on appearance. Particularly in cases in which not only the content of a document, but also the presentation method thereof, is considered important, such as in the case of reports containing color diagrams and/or graphs, or the like, or official documents, where appearance is a requirement, sending documents by facsimile proves to be unsatisfactory.

However, when, for the purposes of using a company internal printer, a dial-up router and a remote access server are provided in a company LAN to permit a dial-up IP connection, a risk is incurred of unauthorized access to a variety of resources in the company LAN from outside the company via the remote access server. Even if the company LAN is protected from unauthorized external access by means of a firewall or similar, there is a possibility that the dial-up router will constitute a hole in security. This is because a dial-up router, in addition to enabling general-purpose data communications using a LAN, may also permit unauthorized access to company internal resources on the LAN if the router is used improperly.

In this regard, the use of VPN technology, for example PPTP (Point-to-Point Tunneling Protocol) may permit access to a company LAN through a firewall without security being compromised. However, the construction of a VPN takes time and is costly, and the maintenance and application thereof place a considerable burden on system managers and thus involve high management costs. Moreover, since users can only make remote access to the print server after temporarily logging on to the company LAN following user confirmation and so forth, straightforward use of internal printers on the company LAN from outside of the company LAN is not possible.

Moreover, the print language (print protocol) which can be interpreted by a printer varies according to the printer type. In other words, a printer is unable to correctly print the above-mentioned print data in a language other than the print language (including emulation mode) which has been pre-installed in the printer. When the printer makes an error in interpreting a print command, a worthless document is outputted in which unintelligible characters and/or symbols are created. When a user is near a printer, he or she is able to specify the printer to be employed and also take care that no mistakes occur in the selection of a printer driver. However, in a case in which a company internal printer is used from a location outside the company LAN, not only is the specification of a printer difficult but also it is not possible to confirm whether or not printing is being performed normally. Consequently, when a user makes a mistake in the selection of a printer driver, a situation arises in which a large amount of scrap print material is produced.

### SUMMARY OF THE INVENTION

In view of the foregoing numerous problems, it is an object of the present invention to provide a public line connection device for a printer, and a print system that enable a printer to be used in a straightforward manner by a terminal device via a public line without security being compromised.

In order to resolve the problems mentioned above, a public line connection device for a printer, and a print system, according to the present invention have the following characteristic features. In other words, a public line connection device for a printer, and a print system comprises: a communication control means that controls data communications via said public line with a terminal device which is connected to said public line; and print control means that transfers print data which is received from said terminal device via said communication control means, to said printer.

For example, a terminal device, such as a personal computer, a mobile information terminal, or a mobile telephone, is connected to a printer via a public line by means of a public line connection device for a printer according to the present invention. Print data, which is sent from the terminal device via the public line, is inputted to the printer via a communication control means and a print control means. The printer performs printing on the basis of the print data that has been inputted. In other words, the communication control means implements a dial-up connection server function. A user is thus able to use a printer by sending print data from an outside of the LAN to the printer via the public line and the public line connection device.

The communication control means performs data communications by means of a PPP (Point-to-Point Protocol) connection with the terminal device. It is preferable that the communication control means should be constituted so as to be incapable of access to a local area network (LAN) to which a printer is connected, or isolates said local area network form said public line. In other words, this public line connection device serves to connect a printer, which has been individually connected, and a terminal device, by means of peer-to-peer communication, but this public line connection device does not have the capability of accessing other resources in the company LAN. As a result, even in a case in which an individual outside the company establishes a dial-up connection to this public line connection device, it is not possible to access all of the resources in the company LAN (shared database, shared files, and so forth).

Furthermore, the print control means can be constituted so as to be capable of sending information relating to a printer to the terminal device.

Here, “information relating to a printer” is considered to mean information relating to a given print environment, and, specifically, this may include, for example: the name of the printer type, the classification of the print method (color-laser printer, monochrome printer, and so forth), functions provided (if there is a double-sided print function, a sort function, and a paper size(s) that may be employed, and so forth), and the print language(s)that may be employed (the variety of PDL (Page Description Language) that can be interpreted). By sending information of this kind to the terminal device, the terminal device is in turn able to issue a print job in a form that is suitable for the printer.

The print control means is also capable of converting printer-independent print data in a printer-independent format received from the terminal device into printer-dependent print data in a printer-dependent format which the printer can interpret.

Here, “print data in a printer-dependent format which the printer can interpret” is print data in a format permitting the printer to generate and print an appropriate print image. In other words, this is the print data described above that is in the print language (print protocol) installed in the printer.

The present invention can also be understood in the form of a print system. In other words, a print system, having a terminal device and a public line connection device which can communicate with the terminal device via a public line, the public line connection device being connected to a printer, in which print data is sent from the terminal device via the public line connection device to the printer, and in which the terminal device comprises: destination specifying means that specifies a destination printer; print data generating means that generates print data to be sent to the destination printer specified by the destination specifying means; and data communication means that sends print data generated by the print data generating means to the destination printer by means of a PPP (Point-to-Point Protocol) connection with the public line connection device; and wherein the public line connection device comprises: communication control means that controls only data communications established by the PPP connection with the terminal device, and is incapable of access to a local area network to which the printer is connected; and print control means that transfers print data received from the terminal device via the communication control means, to the printer, wherein the data communication means can establishes a dial-up connection with the public line connection device.

A user is thus able to use a printer, simply by inputting a document to be printed and the telephone number of a destination printer.

Further, the print data generating means acquires information relating to the printer and thus generates print data in a format that the printer can interpret.

Moreover, the print data generating means generates printer-independent print data in a printer-independent format, and the print control means converts the printer-independent print data into printer-dependent print data in a printer-dependent format which the printer can interpret. In other words, print data in a predetermined printer-independent format that is employed between the terminal device and public line connection device, and this printer-independent print data is then converted by the public line connection device into printer-dependent print data that corresponds to the printer to be used.

### BRIEF DESCRIPTION OF THE DRAWINGS

FIG. 1 is an illustrative view to show an outline of the whole print system according to the embodiments of the present invention;

FIG. 2 is a block diagram to show the constitution of the terminal device according to the first embodiment of the present invention;

FIG. 3 is a block diagram in which the emphasis is on the constitution of the public line connection device;

FIG. 4 is a flow chart to show the flow of dial-up print processing;

FIG. 5 is a flow chart that is a continuation of FIG. 4;

FIG. 6 is a flow chart to show the print language communication process and print language selection process, which are shown in FIG. 4;

FIG. 7 is an illustrative view to show the constitution of the screen for inputting telephone numbers and so forth;

FIG. 8 is an illustrative view to show the public line connection device according to the second embodiment of the present invention in an assembled condition;

FIG. 9 is an illustrative view to show a condition in which a telephone number display section is provided on the outside of the public line connection device;

FIG. 10 is a block diagram relating to the third embodiment of the present invention;

FIG. 11 is a flow chart that schematically shows the main components of dial-up print processing; and

FIG. 12 is a flow chart that shows the processing by the end terminal relating to the fourth embodiment of the present invention.

### DESCRIPTION OF THE PREFERRED EMBODIMENTS

The embodiments of the present invention will be described in detail hereinafter on the basis of the drawings.

1. First Embodiment

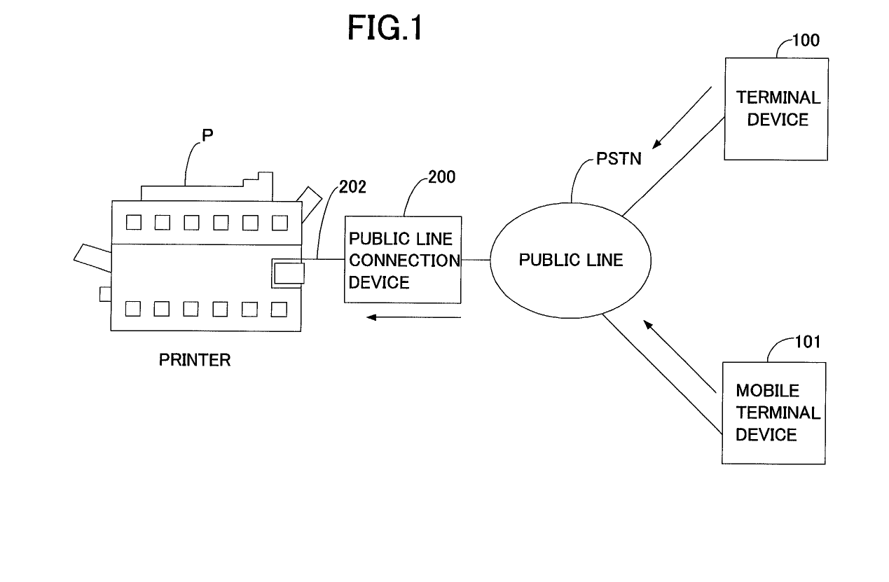

A first embodiment of the present invention will now be described on the basis of FIGS. 1 to 7. FIG. 1 is an illustrative view that shows an outline of the print system according to the present invention. A public line PSTN (Public Switched Telephone Network) has a terminal device 100, a mobile terminal device 101, and a public line connection device 200 respectively connected thereto, and the public line connection device 200 is connected to a printer P such as a laser printer. It should be noted that the printer P is able to connect to a company LAN (not shown in FIG. 1) used inside a certain company, but that the printer P is connected to be public line connection device 200 via a special communication line 202 then than the company LAN. Here, for example, a personal computer, a work station, or a word processor equipped with a communications function, or the like, may be employed as the terminal device 100. Examples of the mobile terminal device 101 may include a PDA (Personal Digital Assistant), a PMC (Personal Mobile Communicator), or a small portable computer (mobile computer). Alternatively, a digital camera or a digital scanner, or the like, which is equipped with a communications function, may also be used as the mobile terminal 101. The public line connection device 200, along with the terminal device 100 and the mobile terminal device 101 (hereinafter both jointly referred to as the terminal device 100, except where explicitly stated) serve to establish a direct connection with the printer P through the use of a PPP (Point-to-Point Protocol) connection. The public line connection device 200 according to the present invention differs from a commonly known dial-up router and remote access server in that this public line connection device 200 is equipped only with a function for a dial-up connection between the printer P and the terminal device 100. However, even in a case in which a public line connection device or a printer are equipped with a LAN connection function, since, according to the present invention, the dial-up connection function and LAN connection function are separate from one another, the scope of the present invention also permits opposition to unauthorized access from outside of the company LAN.

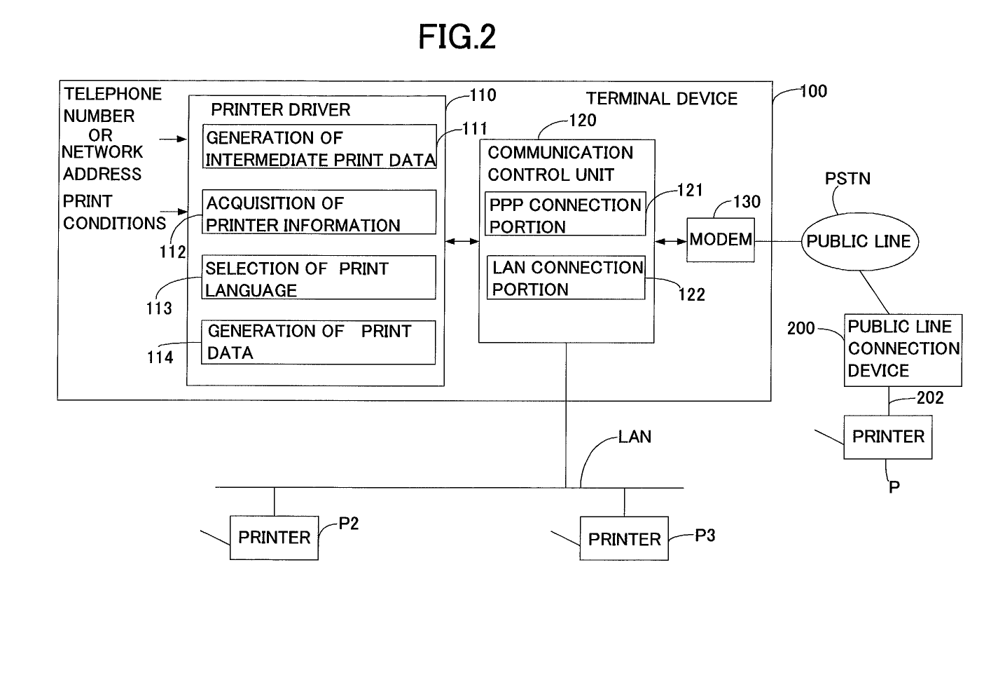

The constitution of the terminal device 100 will now be described by referring to the block diagram of FIG. 2. The terminal device 100 comprises a printer driver 110, a communication control unit 120 and a modem (modulator/DEModulator) 130, and is capable of a connection to the public line PSTN.

When the printer driver 110, which constitutes a “print data generating means”, receives a print instruction from an application program such as text creation software or graphics creation software, the printer driver 110 generates predetermined print data by receiving data from this application program. The printer driver 110 comprises an intermediate data generating portion 111, a printer information acquiring portion 112, a print language selection portion 113 and a print data generating portion 114. The intermediate data generating portion 111 serves to convert document files that are inputted from an application program into the print data described above using an intermediate language before the generation of eventual print data. The printer information acquiring portion 112 serves to seek information regarding the print environment of printer P, that is, learn of the printer type of printer P, the print method thereof, or the variety of print language(s) which the printer can interpret. The print language selection portion 113 serves to select a print language which printer P can interpret from among the print languages that may be implemented by the printer driver 110. The print data generating portion 114 serves to convert the print data described above in an intermediate language into the print data described above, by using the selected print language.

The communication control unit 120, which constitutes the “data communication means”, comprises a PPP connection portion 121, a LAN connection portion 122 and a modem control unit (not shown). The PPP connection portion 121 serves to open and maintain a connection, in the form of a PPP connection, with the terminal device 100 and the public line connection device 200 via the modem 130 and the public line PSTN. The LAN connection portion 122 serves to perform data communications with other network printers P2, P3 connected to a LAN. Further, the terminal device 100 need not comprise a LAN connection portion 122.

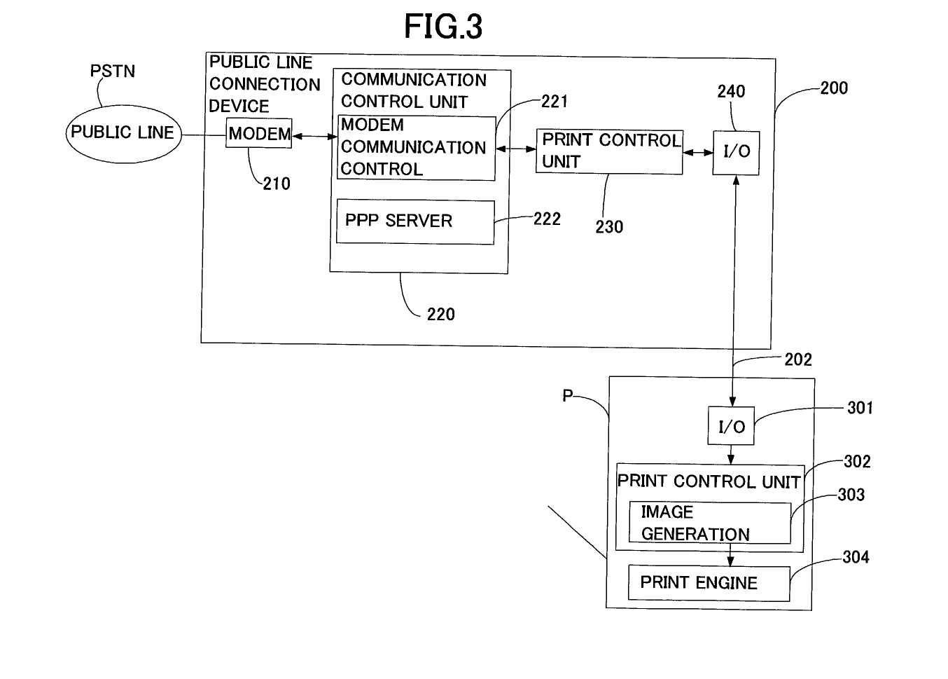

Next, the constitution of the public line connection device 200 will be described by referring to the block diagram of FIG. 3. The public line connection device 200 comprises a modem 210, a communication control unit 220, a print control unit 230 and an input/output portion (I/O) 240. The communication control unit 220, which is a “communication control means”, comprises a modem communication control unit 221 and a PPP server portion 222, and the communication control unit 220 provides the public line connection device 200 with a dial-up connection function. The print control unit 230, which is a “print control means”, inputs print data, inputted from the terminal device 100 via a public line PSTN, to the printer P via the input/output portion 240, and acquires print environment information for the printer P and sends this information to the terminal device 100. The print control unit 230 is different from the print control unit 302 described hereinafter that is provided inside the printer P.

The printer P is constituted comprising an input/output portion 301, a print control unit 302 and a print engine 304. When print data is inputted from the public line connection device 200 via the input/output portion 301, this print data is inputted to an image generating portion 303 via a receive buffer. The image generating portion 303 interprets the print commands for the print data, and, while referencing font data and so forth, generates image data for printing. The generated print data is then inputted to the print engine 304 via an output buffer. The print engine 304 generates a latent image, on the basis of the print image, on a photosensitive drum, for example, and performs printing by causing toner to dissolve and adhere to predetermined locations on printing paper. Further, the printer P is not limited to being a laser printer but instead may also be constituted as a serial printer such as an inkjet printer.

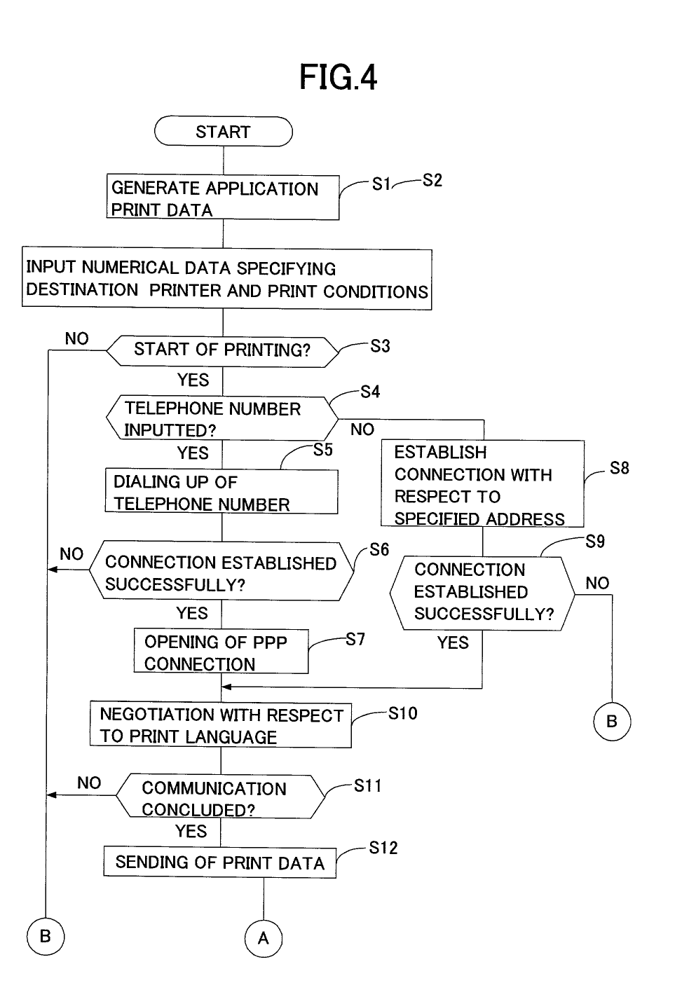

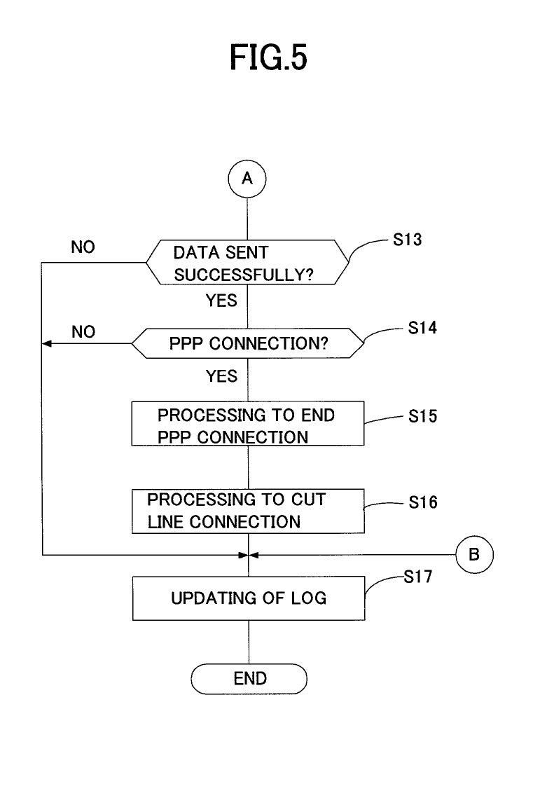

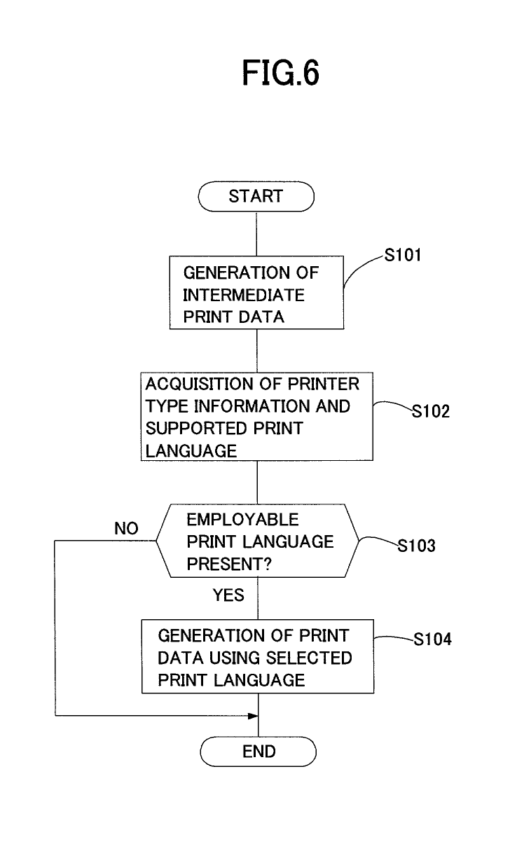

Next, the flow of processing in the present embodiment will be described on the basis of the flow charts of FIGS. 4 to 6. Further, in the description hereinafter, steps are referred to using “S”. FIGS. 4 and 5 show the flow of all dial-up print processing, and FIG. 6 serves to show S10 in FIG. 4 in detail.

The processing of FIG. 4 starts when printing is instructed by an application program. First of all, the print data is generated on the basis of the application program (S1). Next, the user inputs numerical data, such as telephone number or network address, specifying at least one of printers P, P2, P3 and print conditions such as the paper size and number of copies (S2). Then, when the start of printing is requested by the user (S3:YES), a judgement is made as to whether or not the numerical data inputted by the user is a telephone number or a network address (S4). When a telephone number has been inputted (S4:YES), at least one printer P specified by the inputted telephone number is selected as a destination printer, and, in the event that a network address is inputted (S4:NO), at least one network printer P2 or P3 specified by the inputted a network address on a LAN is selected as a destination printer. Through an analysis of the structure of the numerical data inputted by the user, it is possible to distinguish whether the numerical data inputted is a telephone number or a network address. As one example of such analysis, when data that is composed of periods and alphabetical characters is present, it is possible to judge this data to be a network address.

In a case in which a telephone number is inputted (S4:YES), the public line connection device 200 of the destination printer P is called up via the public line PSTN by dialing the telephone number, and a judgement is made as to whether or not a connection via the public line has been established (S5). In a case in which the line connection has been established with the destination printer P (S6:YES), a PPP connection is opened with the PPP server 222 of the public line connection device 200 (S7). Meanwhile, in a case in which a network address is inputted (S4:NO), a connection via the LAN is established with the destination printer P2 or P3 (S8, S9). Further, in a case in which said user input is made that is neither a telephone number nor a network address, this input data is unauthorized and thus canceled.

When a PPP connection is opened with the printer P, the terminal device 100 negotiates with the printer P regarding the print language that is to be employed (S10). This print language selection process will be described hereinafter and with the aid of FIG. 6. When an appropriate print language, which can be interpreted by the printer P, is selected (S11:YES), print data is sent to the printer P by means of a PPP connection over a public line PSTN (S12). Moving now to FIG. 5, when print data has been sent successfully (S13:YES), a judgement is made as to whether or not the PPP connection still remains (S14). In a case in which the PPP connection still remains (S14:YES), after performing processing to end the PPP connection (S15), processing to cut the line connection is performed (S16). Next, after a communication log has been updated, this processing is ended (S17). In a case in which the line connection has not been established (S3:NO, S6:NO, S9:NO, S11:NO), this processing is ended after the communication log has been updated.

FIG. 6 shows one example of the print language selection processing indicated in S10 in FIG. 4. First of all, on the basis of the print data of the application program, intermediate print data is generated that precedes the generation of eventual print data (S101). Thereafter, information regarding the print environment of the printer P is acquired, and a print language, which the printer P can interpret, is confirmed (S102). Also, the information regarding the print environment of the printer P may be acquired whenever dial-up printing is performed, and the information regarding the print environment, which is acquired each time dial-up is performed, is saved in the terminal device 100, and, in a case in which a telephone number, which is to be dialed, is the same as the number dialed on the previous occasion, the information regarding the print environment saved on the previous occasion is read out.

In a case in which a judgement is made as to whether or not a print language which the printer P can interpret is contained in the printer driver 110 of the terminal device 100 (S103), and it is judged that a print language, which the printer P can interpret, is contained therein, the intermediate print data is converted to the eventual print data by using this print language (S104).

In more concrete terms, for example, when the printer driver 110 has three varieties of print languages, PDL1, PDL2, and PDL3, if PDL2 can be interpreted by the printer P, print data is generated by using PDL2. If both PDL2 and PDL3 can be interpreted by the printer P, it is possible to select either one of these appropriate print languages. According to whether or not an emulation mode is in use, and depending on the variety of fonts, and so forth, installed in the printer P, it is possible to make a judgement as to which of the PDLs is appropriate. In a case in which a print language, which the printer P can interpret, is not contained in the printer driver 110, a judgement “NO” is made in S11 in FIG. 4, and the processing is ended. In this case, for example, the printer driver 110 may be such that the required print language is acquired by means of a search of the resources on the LAN.

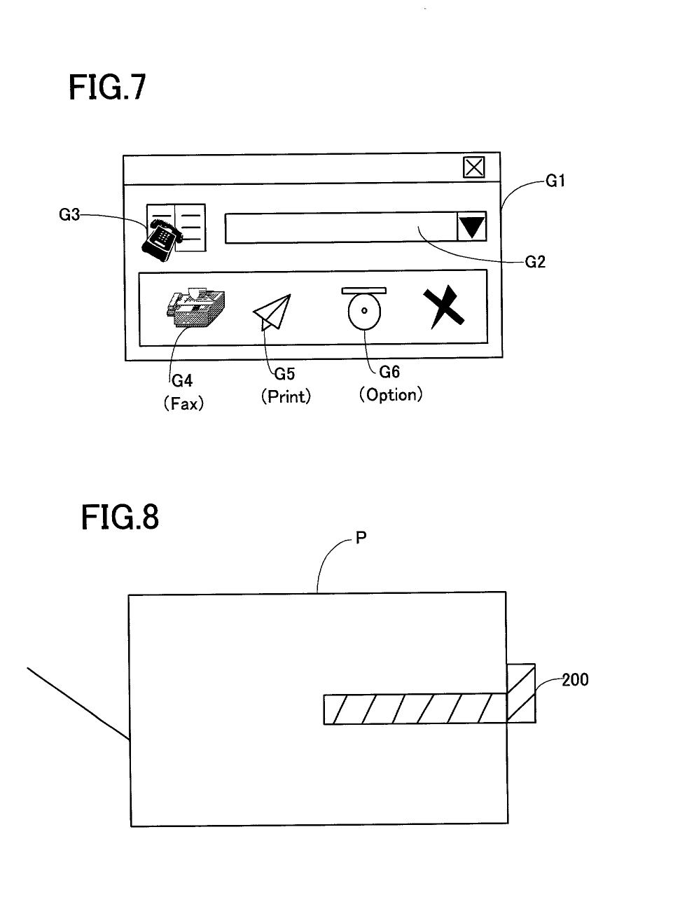

FIG. 7 is one example of an input screen as an “destination specifying means”. When the start of printing is instructed by means of an application program, a dialog box G1 of the kind shown in FIG. 7 is displayed via the user interface of the terminal device 100. A destination entry field G2 is provided in the box G1. The user is thus able to input a telephone number or network address of a destination printer in destination entry field G2 via a keyboard or voice input device, or the like. Further, when the telephone number or network address of the destination printer has already been stored, by selecting a telephone book icon G3, a telephone number or network address, which has been stored, can be indicated in a straightforward manner. In other words, when the telephone book icon G3 is selected with a mouse or the like, since a list of pre-stored telephone numbers and network addresses is presented to the user, the user is able to select the desired one from this list. The selected telephone number or network address is thus inputted in the destination entry field G2.

In addition, a plurality of telephone numbers or network addresses may be simultaneously inputted in destination entry field G2 by separating same using “,”, for example. Or a plurality of destination entry field G2 may be simultaneously displayed on the box G1. For instance, dial-up printing can be performed using two different printers, which are respectively provided in two different locations. Alternatively, it is possible to process the same print job on a network printer P2 which is provided inside the user's company, and also on another printer P provided outside the user's company, such as in the user's client's office. In a case in which a plurality of destination printer are used, print data, which is spooled to a local disk of terminal device 100, might not be deleted until the sending of print data to all of the destination printers is complete, by using flags provided for monitoring whether or not the sending of print data to each of the destination printers has ended. Further, when there is a difference in the print language between the plural destination printers, it is possible to delete each of the spooled print data when each sending of the print data is each destination printer has completed.

The following effects are afforded by an embodiment with such a constitution:

Firstly, since public line connection device 200 implements a dial-up connection server function, the user is able to perform dial-up printing in a straightforward manner by establishing a PPP connection with a printer P via the public line connection device 200 using a terminal device 100. Consequently, in comparison with using a facsimile transmission, it is possible for the print performance of the printer P to be adequately exploited such that high-quality printed matter can be obtained that is visually attractive. Moreover, remote printing can be realized with lower introduction costs and maintenance costs than conventional techniques that make use of VPN technology.

Secondly, since the public line connection device 200 isolates a public line PSTN from a LAN, it is possible to prevent unauthorized access from outside of the LAN to the resources on the LAN via the public line connection device 200. Therefor no holes exist in the security.

Thirdly, since the printer driver 110 of the terminal device 100 automatically determine print language which the printer P can interpret and generates print data using the determined language, it becomes possible to prevent scrap printed material from being output from the printer P. In particular, when dial-up printing is performed using the remote printer P from an outside location, the automatic selection of a suitable print language is highly convenient.

2. Second Embodiment

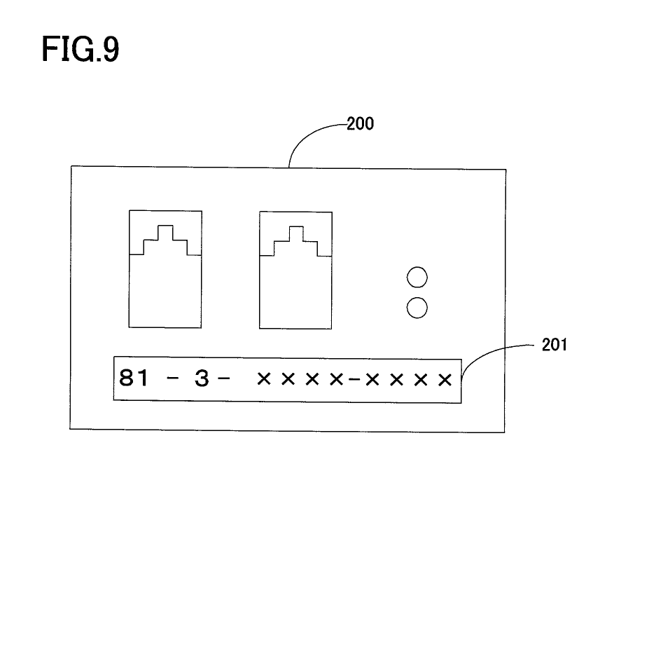

Next, FIGS. 8 and 9 are illustrative views that show a second embodiment of the present invention. In the embodiments below, like reference numerals have been assigned to constituent elements that are the same as the constituent elements of the first embodiment described above and a description of such constituent elements has therefore been omitted. A characteristic feature of the present embodiment is that the telephone number of the printer P is displayed on a public line connection device.

As shown in FIG. 8, the public line connection device 200 is constituted as an extended substrate, and can be provided so as to be integral with and detachable from the printer P. As shown in FIG. 9, on the outside of the public line connection device 200, in other words in a location that is externally visible to the user, a telephone number display section 201 is provided that displays the telephone number which has been allocated to the printer P. The telephone number display section 201 can be constituted as a sticker whereon this telephone number is written or printed. Alternatively, it is also possible to constitute the telephone number display section 201 as an electronic display device such as a liquid-crystal display, LED display or plasma display.

By thus providing a telephone number display section 201 on the public line connection device 200 in a location that is visible to the user, which telephone number display section 201 shows the telephone number linked to the printer P, the user is able to easily confirm the telephone number of the printer P.

3. Third Embodiment

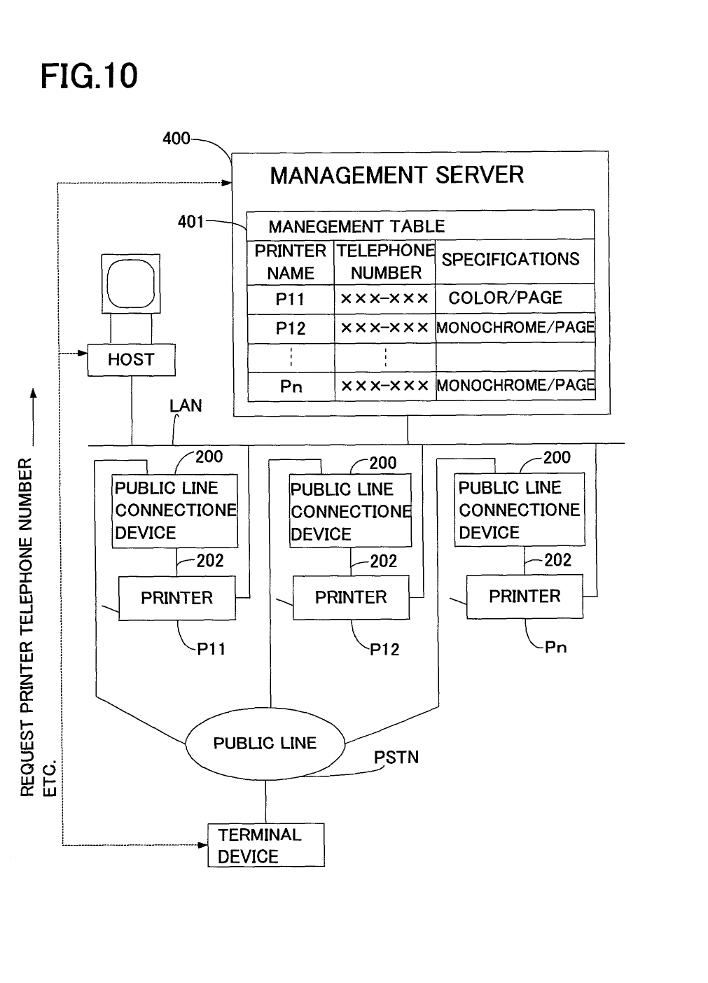

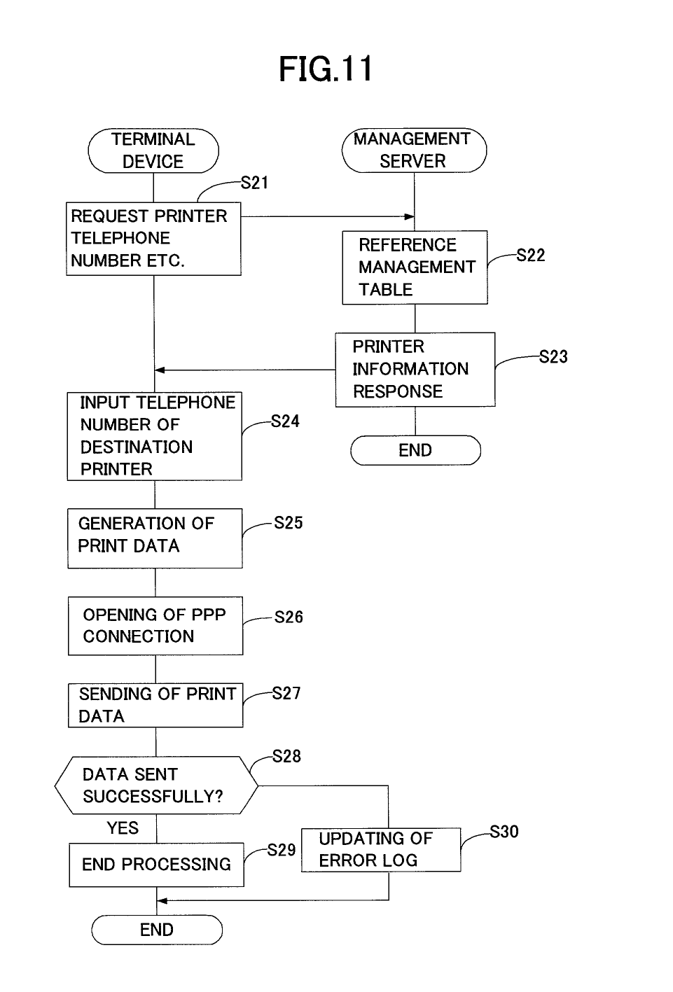

Next, a print system according to a third embodiment of the present invention will be described with reference to FIG. 10 and FIG. 11. A characteristic feature of this embodiment is the provision of a management server 400 for managing respective telephone numbers and print environment information for a plurality of printer that are located on a company LAN inside a certain company. Another characteristic feature is that every printer has a public line connection device 200 so as to be capable of dial-up printing.

The management server 400 is equipped with a management table 401 for the respective saving of telephone numbers and print environment information for each of printers P11 to Pn (collectively called printer P). By referencing management table 401 using requesting information from management server 400, the user is able to find out the telephone number of a given printer P on the company LAN from an outside.

In other words, as shown in FIG. 11, the user is able to request the telephone number and print environment of the printer P from a host computer that is capable of accessing the management server 400 ,or management server 400 (S21). Here, a few methods of requesting such information are possible. A first method is one in which a user places a direct call to an operator of a host computer to request the telephone number of the printer which the user wants to use. In this case, the operator examines the management table 401, and informs the user of the telephone number of the desired printer P. A second method is one in which a request for a confirmation for the management table 401 is made to the operator by the e-mail. In this case, all or part of the management table 401 is sent to the terminal device 100 by the e-mail. A third method is one in which the user remotely accesses management server 400 using VPN technology.

Upon receiving a request for a telephone number or print environment of desired printer P, the management server 400 references the management table 401 and sends the telephone number or print environment of the desired printer P in response (S22, S23). As a consequence, the user is able to input the telephone number of the desired printer P in destination entry field G2 (S24). Further, in a case in which data on all the management table 401 or a part is sent in response by the e-mail, it is possible for the data acquired from the management server 400 to be stored automatically in a telephone book, which is activated by means of a telephone book icon G3. The terminal device 100 then generates the print data, opens a PPP connection with public line connection device 200 of the desired printer, and thus sends the print data (S25 to S30).

Through the provision of the management server 400 for managing telephone numbers and print environment information of the printers, the user is able to confirm from an outside of the LAN by using the management server 400, the telephone number and so forth of a printer P in a straightforward manner.

In addition, in FIG. 10, the printer P is also connected to a LAN. However, isolates the LAN connection function from the dial-up connection server function.

4. Fourth Embodiment

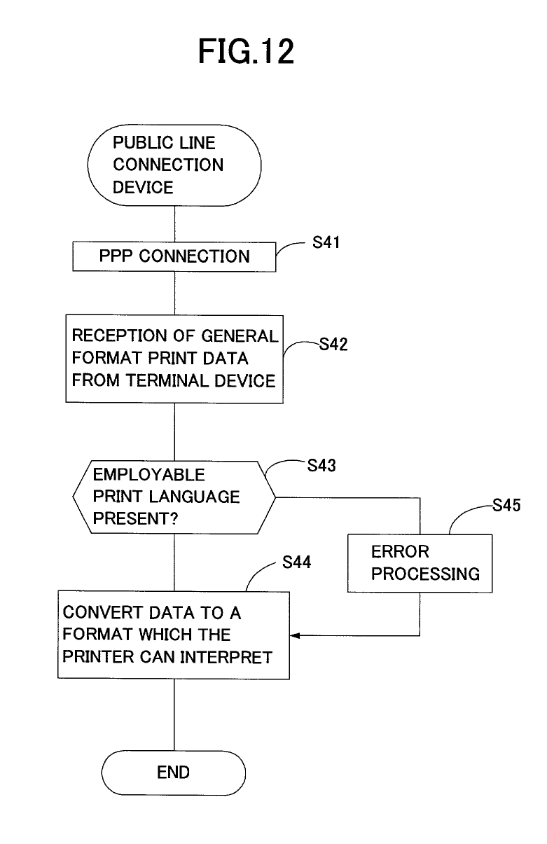

Next, FIG. 12 is a flow chart showing processing according to a fourth embodiment of the present invention. A characteristic feature of this embodiment is that, between the terminal device 100 and public line connection device 200, printer-independent print data of a printer-independent format (or general format) is used, and the printer-independent print data is converted to a printer-dependent format which the destination printer P on the public line connection device 200 side can interpret.

In other words, when a PPP connection via the public line is established (S41), the public line connection device 200 receives print data from the terminal device 100 in the printer-independent format (S42). The public line connection device 200 makes a judgement as to whether or not the public line connection device 200 has a language converter for converting the printer-independent print data into printer-dependent print data in a format of the print language which the printer P can interpret (S43), and, in a case in which the language converter is discovered, the print control unit 230 is used to convert the printer-independent format print data into printer-dependent print data according to the print language which the printer P can interpret (S44). In a case in which the language converter is not contained in the public line connection device 200, error processing is performed (S45).

Since a suitable print language is selected and converted by the public line connection device 200, the processing load on the public line connection device 200 increases; however, soon after the terminal device 100 sends the print data. Consequently, this is effective in a case of mobile communications for which the maintenance of a stable line connection via the public line is difficult. In addition, different results are produced according to the capacity of the buffer memory contained in the public line connection device 200, to the volume of print data received, and to the communication speed, and so on, but in all cases the line connection time can be shortened.

Further, according to the present inventors, within the fundamental scope of the present invention which is described in each of the embodiments, a variety of additions and modifications are possible. For example, a case is exemplified in the first embodiment in which a PPP connection is maintained until the selection of a print language, the generation of print data, and the sending of print data, have all been completed. However, it is possible to constitute the invention such that, for example, after print environment information has been acquired, the temporarily established PPP connection is ended, and, after suitable print data has been generated, the PPP connection is reopened. In this case, since it is possible to shorten the connection time to a public line to equal the time required for the selection of a print language and for the generation of print data, it is possible to reduce communication costs. On the other hand, as in the first embodiment mentioned above, in a case in which the selection of a print language, and the generation and sending of print data are completed using a single PPP connection, although an increase in the communication time would then be expected, there is a decreased risk of print opportunities being wasted. In other words, this is because, in a case in which a PPP connection is made on two separate occasions, when a print job is requested by another terminal device during the time from when the initial PPP connection is broken until a second PPP connection is made, the user is made to wait until the print job having made the interruption is processed.

As described hereinabove, with the public line connection device for a printer, and print system, according to the present invention, it is possible to use a company internal printer from outside of the company LAN and in a straightforward manner whilst still maintaining security.

What is claimed is:

1. A public line connection device for a printer that connects the printer to the public line, comprising:
communication control means that controls data communications via said public line with a terminal device which is connected to said public line; and
print control means that transfers print data which is received from said terminal device via said communication control means, to said printer.

2. The public line connection device for a printer according to claim 1, wherein said communication control means controls only data communications established by a PPP (Point-to-Point Protocol) connection with said terminal device, and is incapable of access to a local area network to which said printer is connected or isolates said local area network from said pubic line.

3. The public line connection device for a printer according either of claims 1 and 2, wherein said print control means is capable of sending information relating to said printer to said terminal device via said communication control means.

4. The public line connection device for a printer according to either of claims 1 and 2, wherein said print data received by said print control means from said terminal device is in a printer-independent format, and said print control means converts said print data received from said terminal device into printer-dependent print data in a printer-dependent format which said printer can interpret.

5. The public line connection device for a printer according to claims 3, wherein said print data received by said print control means from said terminal device is in a printer-independent format, and said print control means converts said print data received from said terminal device into printer-dependent print data in a printer-dependent format which said printer can interpret.

6. A print system, having a terminal device and a public line connection device which can communicate with said terminal device via a public line, said public line connection device being connected to a printer, in which print data is sent from said terminal device via said public line connection device to said printer, wherein said terminal device comprises:
destination specifying means that specifies a destination printer;
print data generating means that generates print data to be sent to said destination printer specified by said destination specifying means; and
data communication means that sends print data generated by said print data generating means to said destination printer by means of a PPP (Point-to-Point Protocol) connection with said public line connection device; and
wherein said public line connection device comprises:
communication control means that controls only data communications established by said PPP connection with said terminal device, and is incapable of access to a local area network to which said printer is connected or isolates said local area network from said pubic line; and
print control means that transfers print data received from said terminal device via said communication control means, to said printer,
wherein said data communication means can establishes a dial-up connection with said public line connection device.

7. The print system according to claim 6, wherein said print data generating means acquires information relating to said destination printer, and then generates print data in a format which said destination printer can interpret.

8. The print system according to claim 6, wherein said print data generating means generates printer-independent print data in a printer-independent format, and said print control means converts said printer-independent print data into printer-dependent print data in a printer-dependent format which the printer can interpret.

9. A printer that performs printing on the basis of print data sent from a terminal device via a public line, comprising:
communication control means that controls only data communications established by a PPP (Point-to-Point Protocol) connection with said terminal device via said public line, and is incapable of access to a local area network or isolates said local area network from said pubic line;
image generating means that generates image data for printing by interpreting print data inputted from said communication control means; and
print means that performs printing on the basis of said image data for printing.
